(19) United States
(12) Patent Application Publication
(10) Pub. No.: US 2018/0137414 A1
(43) Pub. Date: May 17, 2018

(54) CONVOLUTION OPERATION DEVICE AND CONVOLUTION OPERATION METHOD

(71) Applicant: Kneron, Inc., San Diego, CA (US)

(72) Inventors: Li DU, La Jolla, CA (US); Yuan DU, Los Angeles, CA (US); Yi-Lei LI, San Diego, CA (US); Yen-Cheng KUAN, San Diego, CA (US); Chun-Chen LIU, San Diego, CA (US)

(21) Appl. No.: 15/461,928

(22) Filed: Mar. 17, 2017

(30) Foreign Application Priority Data
Nov. 14, 2016 (CN) 201611002217.1

(51) Int. Cl. G06N 3/08; G06N 3/04

(52) U.S. Cl. CPC G06N 3/08; G06N 3/04

(57) ABSTRACT

A convolution operation method includes the following steps of: decomposing a large convolution operation region to multiple small convolution operation regions; the small convolution operation regions perform convolution operations so as to generate partial results, respectively; and summing the partial results as a convolution operation result of the large convolution operation region. A convolution operation device capable of supporting the convolution operation method is also disclosed.

### CROSS REFERENCE TO RELATED APPLICATIONS

This Non-provisional application claims priority under 35 U.S.C. § 119(a) on Patent Application No(s). 201611002217.1 filed in People's Republic of China on Nov. 14, 2016, the entire contents of which are hereby incorporated by reference.

### BACKGROUND OF THE INVENTION

### Field of Invention

The present disclosure relates to a convolution operation device and a convolution operation method. In particular, the present disclosure relates to a convolution operation device and a convolution operation method, which can decompose a large convolution operation region to multiple small convolution operation regions for performing convolution operations.

### Related Art

Deep learning is an important technology for developing artificial intelligence (AI). In the recent years, the convolutional neural network (CNN) is developed and applied in the identification of the deep learning field. The convolutional neural network is composed of a plurality of characteristics filters, which are connected in parallel. The scale of the convolution operation region of the filter can be a small convolution operation region (e.g. 1×1 or 3×3) or a large convolution operation region (e.g. 5×5, 7×7, or 11×11).

However, the convolution operation usually consumes a lot of performance. In particularly, the convolution operation for large convolution operation region can occupy most performance of the processor. In addition, the filter of the convolution operation unit for operating data characteristics is usually designed to operate with specific scale of convolution operation regions or specific inputted data scale. Accordingly, the convolution operation unit usually has the operation limitation or hardware support limitation for operating the scale smaller than the convolution operation region. If it is desired to perform the operation with a larger convolution operation region, the assistant of software or additional hardware resource is needed.

Therefore, it is desired to disclose a convolution operation method that can obtain the convolution operation results of large convolution operation region with reducing the limitation of specific scale of convolution operation region and without the additional hardware resource.

### SUMMARY OF THE INVENTION

In view of the foregoing, an objective of the present disclosure is to provide a convolution operation device and a convolution operation method that can obtain the convolution operation results of large convolution operation region with reducing the limitation of specific scale of convolution operation region and without the additional hardware resource.

To achieve the above objective, the present invention discloses a convolution operation method, which includes the following steps of: decomposing a large convolution operation region to multiple small convolution operation regions; performing convolution operations by the small convolution operation regions so as to generate partial results, respectively; and summing the partial results as a convolution operation result of the large convolution operation region.

In one embodiment, the small convolution operation regions have the same scale.

In one embodiment, the convolution operation method further includes a step of: assigning 0 to the small convolution operation regions, which are exceeding the large convolution operation region.

In one embodiment, in the step of performing the convolution operations, the small convolution operation regions utilize at least a convolution unit to perform the convolution operations so as to generate the partial results, and a scale of the small convolution operation region is equal to a maximum convolution scale capable of being supported by the convolution unit.

In one embodiment, in the step of performing the convolution operations, the small convolution operation regions utilize convolution units of corresponding numbers to perform the convolution operations in parallel so as to generate the partial results.

In one embodiment, the large convolution operation region includes a plurality of filter coefficients, and the filter coefficients are assigned to the small convolution operation regions according to an order of the filter coefficients and scales of the small convolution operations regions.

In one embodiment, the large convolution operation region includes a plurality of data, and the filter coefficients are assigned to the small convolution operation regions according to an order of the data and scales of the small convolution operations regions.

In one embodiment, a scale of the large convolution operation region is 5×5 or 7×7, and a scale of the small convolution operation regions is 3×3.

In one embodiment, the step of summing the partial results further includes: providing a plurality of moving addresses to the small convolution operation regions, wherein the partial results move in a coordinate according to the moving addresses and added.

In one embodiment, the convolution operation method further includes the step of: determining a convolution operation mode according to a scale of a current convolution operation region. When the convolution operation mode is a decomposed mode, the current convolution operation region is the large convolution operation region. Thus, the large convolution operation region is decomposed to the multiple small convolution operation regions, the small convolution operation regions perform the convolution operations so as to generate the partial results, respectively, and the partial results are summed as the convolution operation result of the large convolution operation region. When the convolution operation mode is a non-decomposed mode, the current convolution operation region is not decomposed and directly performs is the convolution operation.

In one embodiment, the convolution operation method further includes the step of: performing a partial operation of a consecutive layer of a convolutional neural network.

To achieve the above objective, the present invention also discloses a convolution operation device that can perform the steps of the above-mentioned convolution operation method.

As mentioned above, the convolution operation method of the invention includes the following steps of: decomposing a large convolution operation region to multiple small convolution operation regions; performing convolution operations by the small convolution operation regions so as to generate partial results, respectively; and summing the partial results as a convolution operation result of the large convolution operation region. Accordingly, the convolution operation device and method can obtain the convolution operation results of large convolution operation region with reducing the limitation of specific scale of convolution operation region and without the additional hardware resource.

### BRIEF DESCRIPTION OF THE DRAWINGS

The invention will become more fully understood from the detailed description and accompanying drawings, which are given for illustration only, and thus are not limitative of the present invention, and wherein:

FIG. 1 is a schematic diagram showing a convolution operation with a two dimensional data;

FIG. 2 is a schematic diagram of a convolution unit;

FIG. 3A is a schematic diagram showing a 5×5 large convolution operation region, which is decomposed into four 3×3 small convolution operation regions;

FIG. 3B is a schematic diagram of assigning a plurality of filter coefficients to the convolution operation regions according to the order and scales of the convolution operation regions;

FIG. 3C is a schematic diagram of assigning a plurality of data to the convolution operation regions according to the order and scales of the convolution operation regions;

FIG. 4 is a schematic diagram showing a 7×7 large convolution operation region, which is decomposed into nine 3×3 small convolution operation regions;

FIG. 5 is a block diagram showing a convolution operation device according to an embodiment of the invention;

FIG. 6 is a schematic diagram showing a part of the convolution operation device of FIG. 5; and

FIG. 7 is a block diagram showing a convolution unit according to an embodiment of the invention.

### DETAILED DESCRIPTION OF THE INVENTION

The present invention will be apparent from the following detailed description, which proceeds with reference to the accompanying drawings, wherein the same references relate to the same elements.

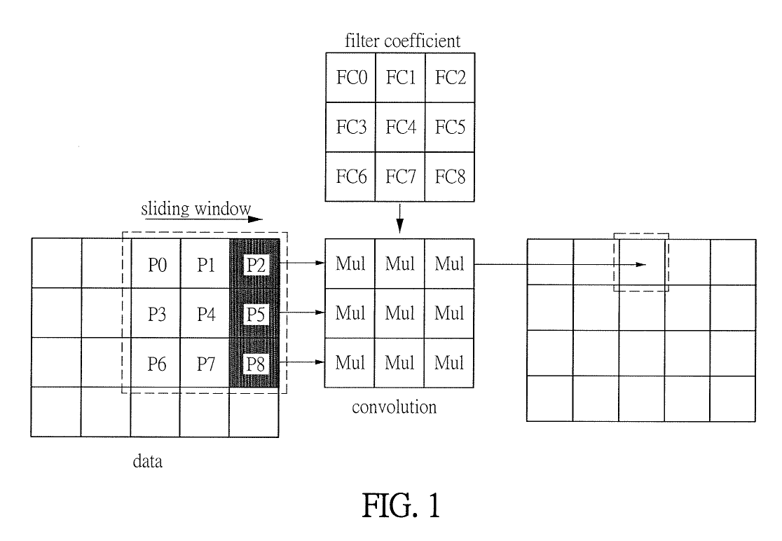

FIG. 1 is a schematic diagram showing a convolution operation with a 2D (two dimensional) data. The 2D data has multiple columns and multiple rows, and the 2D data can be an image data such as 5×4 pixels. As shown in FIG. 1, a filter of a 3×3 array can be used in the convolution operation for 2D data. The filter has the coefficients FC0˜FCB, and the stride of the filter is smaller than the shortest width of the filter. The size of the filter matches the sliding window or convolution operation window. The sliding window can move on the 5×4 image. In each movement, a 3×3 convolution operation is executed regarding to the data P0˜P8 corresponding to the window. The result of the convolution operation is named as a characteristics value. The moving distance of the sliding window S is a stride. The size of the stride is smaller than the size of the sliding window or the convolution size. In this embodiment, the stride of the sliding window is smaller than the distance of three pixels. In general, the adjacent convolution operations usually have overlapped data. If the stride is 1, the data P2, P5 and P8 are the new data, and the data P0, P1, P3, P4, P6 and P7 have been inputted in the previous convolution operation. In the convolutional neural network, the common size of the sliding window can be 1×1, 3×3, 5×5, 7×7, or the likes. In this embodiment, the size of the sliding window is 3×3.

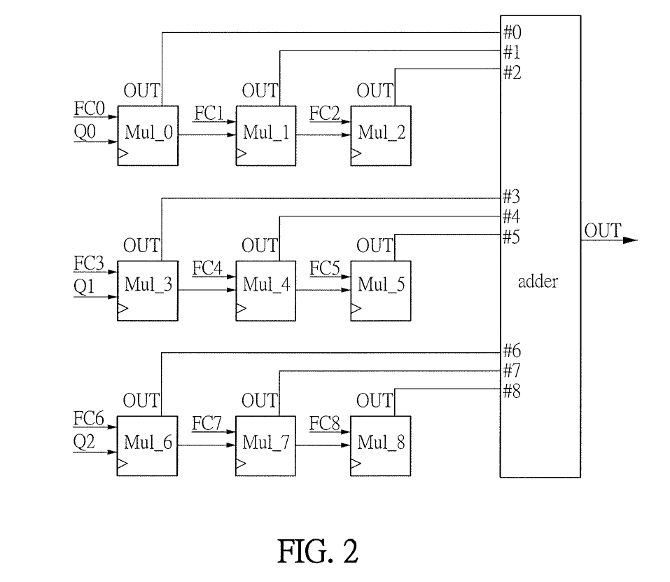

FIG. 2 is a schematic diagram showing a convolution unit. The convolution unit of FIG. 2 can perform the convolution operation of FIG. 1. As shown in FIG. 2, the convolution unit has 9 multipliers Mul_0˜Mul_8 in a 3×3 array. Each multiplier has a data input, a filter coefficient input, and a multiplication output OUT. The data input and the filter coefficient input are the two multiplication operation inputs of each multiplier. The outputs OUT of the multipliers are connected to the inputs #0˜#8 of the adders. The adders can add the outputs of the multipliers and then generate a convolution output OUT. After finishing a convolution operation, the multipliers Mul_0, Mul_3 and Mul_6 can output the current data (the current inputs Q0, Q1 and Q2) to the next multipliers Mul_1, Mul_4 and Mul_7. The multipliers Mul_1, Mul_4 and Mul_7 can output the current data (the previous inputs Q0, Q1 and Q2) to the next multipliers Mul_2, Mul_5 and Mul_8. Accordingly, the data inputted to the convolution units in the previous operation can be remained for next convolution operation. The multipliers Mul_0, Mul_3 and Mul_6 can receive new data Q0, Q1 and Q2 in the next convolution operation. The patch between two consequent convolution operations is at least one clock.

In general, the filter coefficients are not renewed frequently. For example, the coefficients FC0˜FC8 are inputted to the multipliers Mul_0˜Mul_8 and remained in the multipliers Mul_0˜Mul_8 for the following multiplication operations. Otherwise, the coefficients FC0˜FC8 must be continuously inputted to the multipliers Mul_0˜Mul_8.

In other aspects, the convolution units can be in a 5×5 array or a 7×7 array rather than the above-mentioned 3×3 array. This invention is not limited. The convolution units PE can simultaneously execute multiple convolution operations for processing different sets of inputted data.

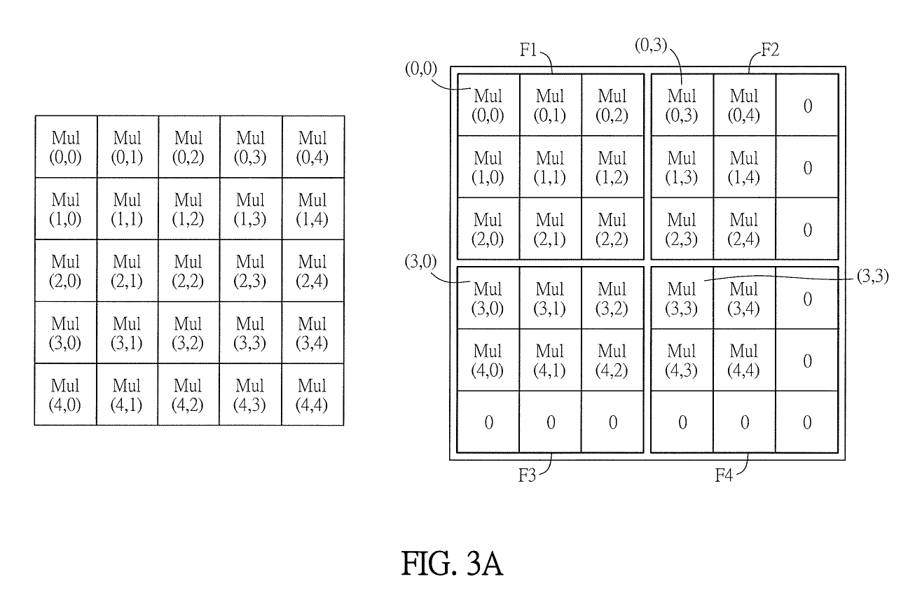

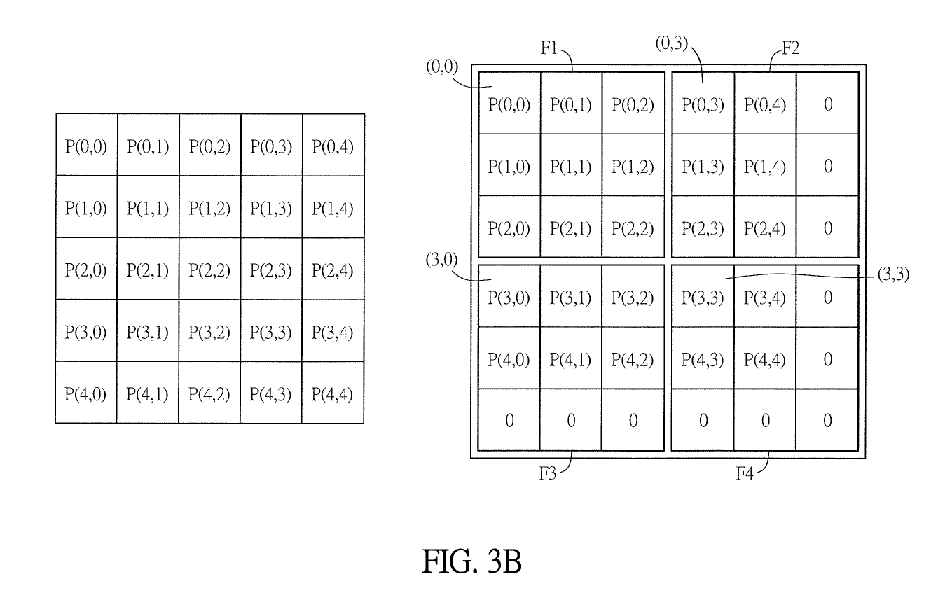

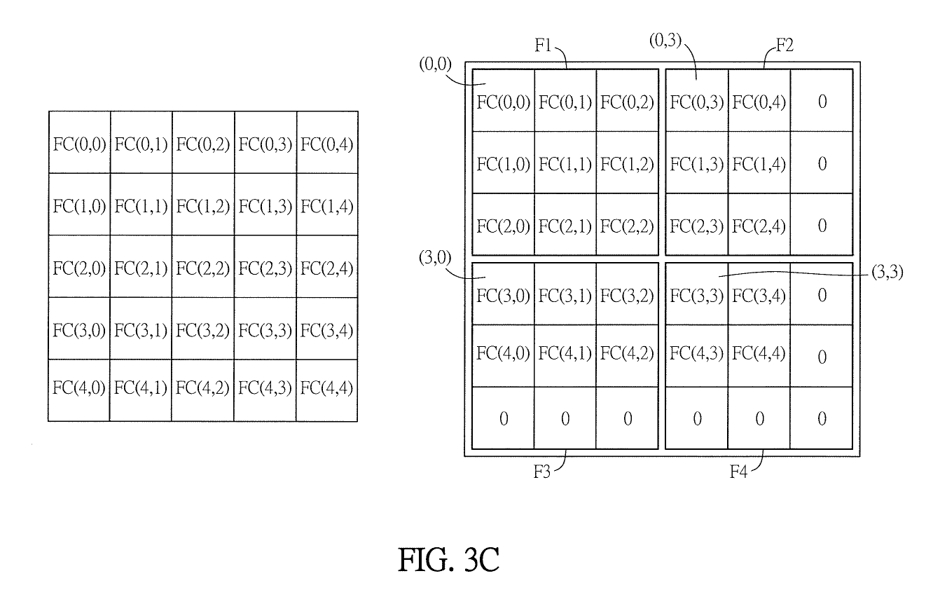

FIG. 3A is a schematic diagram showing a 5×5 large convolution operation region, which is decomposed into four 3×3 small convolution operation regions, FIG. 3B is a schematic diagram of assigning a plurality of filter coefficients to the convolution operation regions according to the order and scales of the convolution operation regions, and FIG. 3C is a schematic diagram of assigning a plurality of data to the convolution operation regions according to the order and scales of the convolution operation regions.

Referring to FIG. 3A, a filter for processing 2D 5×5 pixel data in priority is provided. This filter can be a 5×5 convolution operation unit array or a 5×5 large convolution operation region. FIG. 3B shows the 5×5 pixel data corresponding to the original 5×5 large convolution operation region. In general, utilizing the 5×5 large convolution operation region to process the 5×5 pixel data is much simple and more coefficient. However, if the hardware of the convolution operation device can't support the convolution operation for 5×5 convolution operation region, it is necessary to perform the convolution operation by another way.

Referring to FIG. 3A, the original 5×5 large convolution operation region is decomposed into a plurality of small convolution operation regions. In this embodiment, the original 5×5 large convolution operation region is decomposed into four 3×3 small convolution operation regions, and these small convolution operation regions are all in the same size. In another aspect, the original 5×5 or 7×7 large convolution operation region can be decomposed into more small convolution operation regions (e.g. 1×1 small convolution operation regions). This invention is not limited. To be noted, the columns and rows of the 5×5 large convolution operation region are not integral multiples of the columns and rows of the small convolution operation region, and the sum of the four small convolution operation regions is larger than the original 5×5 large convolution operation region. Accordingly, the convolution operation method of the invention needs to assign 0 to a part of the small convolution operation regions, which are exceeding the large convolution operation region. In this embodiment, a virtual 6×6 large convolution operation region is created by adding a column and a row to the original 5×5 large convolution operation region, and the coefficients of the added column and row are assigned with 0. Accordingly, the virtual 6×6 large convolution operation region is an integral multiple of the small convolution operation region, which means the virtual 6×6 large convolution operation region can be divided into multiple small convolution operation regions and the small convolution operation regions are non-overlapping. After dividing or decomposing the large convolution operation region, there are totally four 3×3 small convolution operation regions generated, which are the small convolution operation regions F1˜F4.

Afterwards, it is possible to perform the desired convolution operations for the pixel data with the obtained small convolution operation regions F1˜F4, thereby generating partial results (image results), respectively. FIGS. 3B and 3C disclose that the large convolution operation region includes a plurality of filter coefficients and data. The filter coefficients and data can be assigned to the small convolution operation regions F1˜F4 according to the order thereof and the scales of the small convolution operation regions F1˜F4.

In the convolution operation step, the small convolution operation regions F1˜F4 utilize at least one convolution unit to perform the convolution operations for generating the partial results. In this embodiment, the small convolution operation regions F1˜F4 utilize four convolution units to perform the convolution operations (F4 includes only four convolution units), and the scale of the small convolution operation regions F1˜F4 is equal to the maximum convolution scale that can be supported by the convolution units. In other words, the small convolution operation regions F1˜F4 is the limit of the hardware support, such as for the 3×3 convolution operation region. In addition, the small convolution operation regions F1˜F4 utilize the corresponding number of convolution units for performing the parallel convolution operations to generate the partial results, respectively.

After the small convolution operation regions F1˜F4 perform convolution operations to generate the partial results, respectively, the generated partial results are then summed as the convolution operation result of the 5×5 large convolution operation region. In practice, a plurality of moving addresses are assigned to the small convolution operation regions, and the partial results are moved in one coordinate according to the provided moving addresses and then summed. For example, the moving addresses (0,0), (0,3), (3,0) and (3,3) are assigned to the small convolution operation regions F1, F2, F3 and F4. The small convolution operation regions F1˜F4 are non-overlapping and have different moving addresses, so that the small convolution operation regions F1˜F4 can scan the data (pixel data) of FIG. 3B according to the filter coefficients so as to generate the partial results I1˜I4 and the final partial result I5 (not shown). Finally, the initial buffer value of the final partial result I5 is set as 0, and the partial results I1˜I4 outputted from the four small convolution operation regions F1˜F4 are summed.

Since the moving address of the small convolution operation region F1 is (0,0), the partial result I1 is directly added to the final partial result I5. Since the moving address of the small convolution operation region F2 is (0,3), the partial result I2 is added to the final partial result I5 at the coordinates (X,Y−3). Since the moving address of the small convolution operation region F3 is (3,0), the partial result I3 is added to the final partial result I5 at the coordinates (X−3,Y). Since the moving address of the small convolution operation region F4 is (3,3), the partial result I4 is added to the final partial result I5 at the coordinates (X−3,Y−3). Accordingly, the partial results I1˜I4 outputted from the small convolution operation regions are added in the coordinate according to the different moving addresses, thereby generating the desired final partial result I5.

In this embodiment, the convolution operation method includes the following steps of: decomposing a large convolution operation region to multiple small convolution operation regions (step S10); performing convolution operations by the small convolution operation regions so as to generate partial results, respectively (step S20); and summing the partial results as a convolution operation result of the large convolution operation region (step S30).

Moreover, in the step S10, when the small convolution operation regions exceed the large convolution operation region, the convolution operation method further includes a step of: assigning 0 to the small convolution operation regions, which are exceeding the large convolution operation region (step S11). Besides, the step S30 further includes a step S31 for providing a plurality of moving addresses to the small convolution operation regions, wherein the partial results move in a coordinate according to the moving addresses and added.

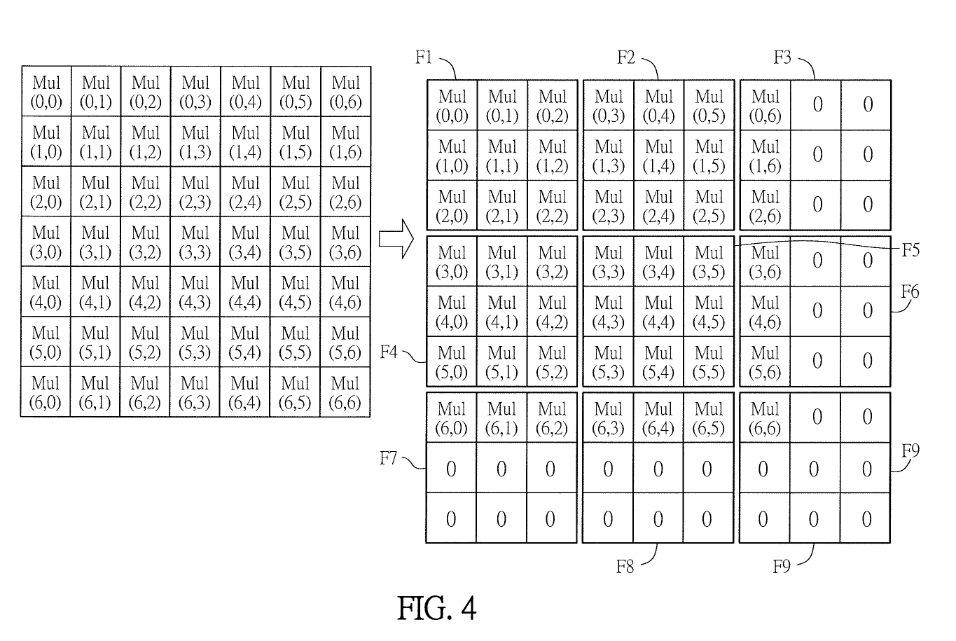

FIG. 4 is a schematic diagram showing a 7×7 large convolution operation region, which is decomposed into nine 3×3 small convolution operation regions.

Similar to the above embodiment of the 5×5 large convolution operation region, this embodiment has a 7×7 large convolution operation region. The columns and rows of the 7×7 large convolution operation region are also not integral multiples of the columns and rows of the 3×3 small convolution operation region, and nine small convolution operation regions are larger than the original 7×7 large convolution operation region. Accordingly, the convolution operation method of the invention needs to assign 0 to a part of the small convolution operation regions, which are exceeding the large convolution operation region. In this embodiment, a virtual 9×9 large convolution operation region is created by adding two columns and two rows to the original 7×7 large convolution operation region, and the coefficients of the added columns and rows are assigned with 0. Accordingly, the virtual 9×9 large convolution operation region is an integral multiple of the small convolution operation region, which means the virtual 9×9 large convolution operation region can be divided into multiple small convolution operation regions and the small convolution operation regions are non-overlapping. After dividing or decomposing the large convolution operation region, there are totally nine 3×3 small convolution operation regions generated, which are the small convolution operation regions F1˜F9. Finally, the small convolution operation regions F1˜F9 can output partial results I1˜I9, respectively, and the partial results I1˜I9 are moved in the coordinate according to different moving addresses and then added, thereby generating the final partial result I10.

The technical features of this embodiment for dividing the 7×7 large convolution operation region into nine 3×3 small convolution operation regions can be referred to the previous embodiment, so the detailed descriptions thereof will be omitted.

In one embodiment, the convolution operation method further includes a step of: determining a convolution operation mode according to a scale of a current convolution operation region. Accordingly, the convolution operation method of this invention can select a proper convolution operation mode to process the region of different scales.

When the convolution operation mode is a decomposed mode, the current convolution operation region is the large convolution operation region. Thus, the large convolution operation region is decomposed to the multiple small convolution operation regions, the small convolution operation regions perform the convolution operations so as to generate the partial results, respectively, and the partial results are summed as the convolution operation result of the large convolution operation region.

When the convolution operation mode is a non-decomposed mode, the current convolution operation region is not decomposed and directly performs the convolution operation.

In addition, the convolution operation method further includes the step of: performing a partial operation of a consecutive layer of a convolutional neural network. The partial operation can be a sum operation, an average operation, a maximum value operation, or other operations of a consecutive layer, and it can be executed in the current layer of the convolutional neural network.

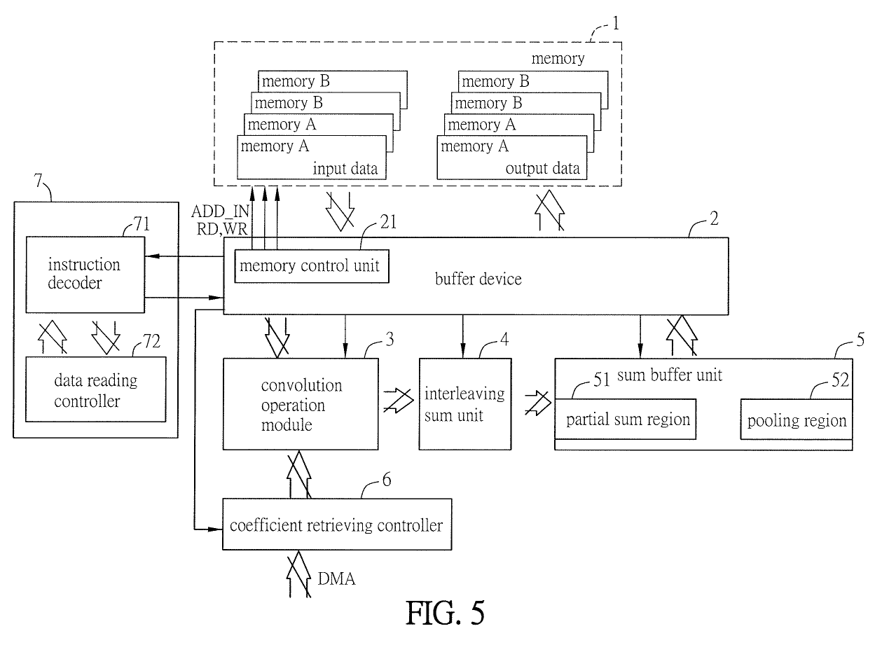

The aspects of the hardware for supporting the above operation will be illustrated hereinafter. FIG. 5 is a block diagram showing a convolution operation device according to an embodiment of the invention. As shown in FIG. 5, the convolution operation device includes a memory 1, a buffer device 2, a convolution operation module 3, an interleaving sum unit 4, a sum buffer unit 5, a coefficient retrieving controller 6 and a control unit 7. The convolution operation device can be applied to convolutional neural network (CNN).

The memory 1 stores the data for the convolution operations. The data include, for example, image data, video data, audio data, statistics data, or the data of any layer of the convolutional neural network. The image data may contain the pixel data. The video data may contain the pixel data or movement vectors of the frames of the video, or the audio data of the video. The data of any layer of the convolutional neural network are usually 2D array data, such as 2D array pixel data. In this embodiment, the memory 1 is a SRAM (static random-access memory), which can store the data for convolution operation as well as the results of the convolution operation. In addition, the memory 1 may have multiple layers of storage structures for separately storing the data for the convolution operation and the results of the convolution operation. In other words, the memory 1 can be a cache memory configured in the convolution operation device.

All or most data can be stored in an additional device, such as another memory (e.g. a DRAM (dynamic random access memory)). All or a part of these data are loaded into the memory 1 from the another memory when executing the convolution operation. Then, the buffer device 2 inputs the data into the convolution operation module 3 for executing the convolution operations. If the inputted data are from the data stream, the latest data of the data stream are written into the memory 1 for the convolution operations.

For example, the control unit or processing unit can control to select one convolution operation mode. When the control unit or processing unit discovers that the scale of the convolution operation region is larger than the maximum scale capable of being processed by the hardware, it will switch to the decomposing mode for operation. For example, if the hardware of the convolution operation module 3 can only support up to 3×3 convolution operation, the control unit or processing unit will decompose the current convolution operation region into multiple 3×3 convolution operation regions, write the 3×3 convolution operation regions to the memory 1, and then command the convolution operation device to perform 3×3 convolution operations with the 3×3 convolution operation regions. Accordingly, the convolution operation module 3 can perform 3×3 convolution operations with the 3×3 convolution operation regions to generate the partial results, which are added to obtain the convolution operation result of the current convolution operation region. For example, the sum buffer unit 5 can sum the partial results, and the sum is written into the memory 1 through the buffer device 2. The control unit or processing unit can retrieve the convolution operation result of the current convolution operation region from the memory 1. In addition, the partial results may be directly written into the memory 1 through the buffer device 2 without being summed by the sum buffer unit 5. Then, the control unit or processing unit can retrieve the partial results from the memory 1 and then sum the partial results as the convolution operation result of the current convolution operation region.

The buffer device 2 is coupled to the memory 1, the convolution operation module 3 and a part of the sum buffer unit 5. In addition, the buffer device 2 is also coupled to other components of the convolution operation device such as the interleaving sum unit 4 and the control unit 7. Regarding to the image data or the frame data of video, the data are processed column by column and the data of multiple rows of each column are read at the same time. Accordingly, within a clock, the data of one column and multiple rows in the memory 1 are inputted to the buffer device 2. In other words, the buffer device 2 is functioned as a column buffer. In the operation, the buffer device 2 can retrieve the data for the operation of the convolution operation module 3 from the memory 1, and modulate the data format to be easily written into the convolution operation module 3. In addition, the buffer device 2 is also coupled with the sum buffer unit 5, the data processed by the sum buffer unit 5 can be reordered by the buffer device 2 and then transmitted to and stored in the memory 1. In other words, the buffer device 2 has a buffer function as well as a function for relaying and registering the data. In more precisely, the buffer device 2 can be a data register with reorder function.

To be noted, the buffer device 2 further includes a memory control unit 21. The memory control unit 21 can control the buffer device 2 to retrieve data from the memory 1 or write data into the memory 1. Since the memory access width (or bandwidth) of the memory 1 is limited, the available convolution operations of the convolution operation module 3 is highly related to the access width of the memory 1. In other words, the operation performance of the convolution operation module 3 is limited by the access width. When reaching the bottleneck of the input from the memory, the performance of the convolution operation can be impacted and decreased.

The convolution operation module 3 includes a plurality of convolution units, and each convolution unit executes a convolution operation based on a filter and a plurality of current data. After the convolution operation, a part of the current data is remained for the next convolution operation. The buffer device 2 retrieves a plurality of new data from the memory 1, and the new data are inputted from the buffer device 2 to the convolution unit. The new data are not duplicated with the current data. For example, the new data are not counted in the previous convolution operation, but are used in the current convolution operation. The convolution unit of the convolution operation module 3 can execute a next convolution operation based on the filter, the remained part of the current data, and the new data. The interleaving sum unit 4 is coupled to the convolution operation module 3 and generates a characteristics output result according to the result of the convolution operation. The sum buffer unit 5 is coupled to the interleaving sum unit 4 and the buffer device 2 for registering the characteristics output result. When the selected convolution operations are finished, the buffer device 2 can write all data registered in the sum buffer unit 5 into the memory 1.

The coefficient retrieving controller 6 is coupled to the convolution operation module 3, and the control unit 7 is coupled to the buffer device 2. In practice, the convolution operation module 3 needs the inputted data and the coefficient of filter for performing the related operation. In this embodiment, the needed coefficient is the coefficient of the 3×3 convolution unit array 30. The coefficient retrieving controller 6 can directly retrieve the filter coefficient from external memory by direct memory access (DMA). Besides, the coefficient retrieving controller 6 is also coupled to the buffer device 2 for receiving the instructions from the control unit 7. Accordingly, the convolution operation module 3 can utilize the control unit 7 to control the coefficient retrieving controller 6 to perform the input of the filter coefficient.

The control unit 7 includes an instruction decoder 71 and a data reading controller 72. The instruction decoder 71 receives an instruction from the data reading controller 72, and then decodes the instruction for obtaining the data size of the inputted data, columns and rows of the inputted data, the characteristics number of the inputted data, and the initial address of the inputted data in the memory 1. In addition, the instruction decoder 71 can also obtain the type of the filter and the outputted characteristics number from the data reading controller 72, and output the proper blank signal to the buffer device 2. The buffer device 2 can operate according to the information provided by decoding the instruction as well as controlling the operations of the convolution unit array 30 and the sum buffer unit 5. For example, the obtained information may include the clock for inputting the data from the memory 1 to the buffer device 2 and the convolution unit array 30, the sizes of the convolution operations of the convolution operation module 3, the reading address of the data in the memory 1 to be outputted to the buffer device 2, the writing address of the data into the memory 1 from the sum buffer unit 5, and the convolution modes of the convolution unit array 30 and the buffer device 2.

In addition, the control unit 7 can also retrieve the needed instruction and convolution information from external memory by data memory access. After the instruction decoder 71 decodes the instruction, the buffer device 2 retrieves the instruction and the convolution information. The instruction may include the size of the stride of the sliding window, the address of the sliding window, and the numbers of columns and rows of the image data.

The sum buffer unit 5 is coupled to the interleaving sum unit 4. The sum buffer unit 5 includes a partial sum region 51 and a pooling region 52. The partial sum region 51 is configured for registering data outputted from the interleaving sum unit 4. The pooling region 52 performs a pooling operation with the data registered in the partial sum region 51. The pooling operation is a max pooling or an average pooling.

For example, the convolution operation results of the convolution operation module 3 and the output characteristics results of the interleaving sum unit 4 can be temporarily stored in the partial sum region 51 of the sum buffer unit 5. Then, the pooling region 52 can perform a pooling operation with the data registered in the partial sum region 51. The pooling operation can obtain the average value or max value of a specific characteristics in one area of the inputted data, and use the obtained value as the fuzzy-rough feature extraction or statistical feature output. This statistical feature has lower dimension than the above features and is benefit in improving the operation results.

To be noted, the partial operation results of the inputted data are summed (partial sum), and then registered in the partial sum region 51. The partial sum region 51 can be referred to a PSUM unit, and the sum buffer unit 5 can be referred to a PSUM buffer module. In addition, the pooling region 52 of this embodiment obtains the statistical feature output by max pooling. In other aspects, the pooling region 52 may obtain the statistical feature output by average pooling. This invention is not limited. After inputted data are all processed by the convolution operation module 3 and the interleaving sum unit 4, the sum buffer unit 5 outputs the final data processing results. The results can be stored in the memory 1 through the buffer device 2, and outputted to other components through the memory 1. At the same time, the convolution unit array 30 and the interleaving sum unit 4 can continuously obtain the data characteristics and perform the related operations, thereby improving the process performance of the convolution operation device.

The convolution operation device may include a plurality of convolution operation modules 3. The convolution units of the convolution operation modules 3 and the interleaving sum unit 4 can optionally operated in the low-scale convolution mode or a high-scale convolution mode. In the low-scale convolution mode, the interleaving sum unit 4 is configured to sum results of the convolution operations of the convolution operation modules 3 by interleaving so as to output sum results. In the high-scale convolution mode, the interleaving sum unit 4 is configured to sum the results of the convolution operations of the convolution units as outputs.

For example, the control unit 7 can receive a control signal or a mode instruction, and then select one of the convolution modes for the other modules and units according to the received control signal or mode instruction. The control signal or mode instruction can be outputted from another control unit or processing unit.

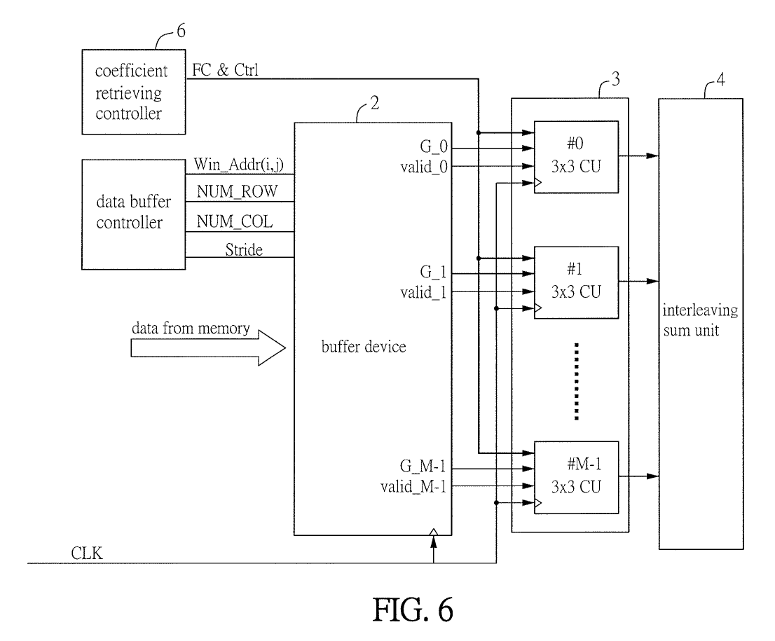

FIG. 6 is a schematic diagram showing a part of the convolution operation device of FIG. 5. Referring to FIG. 6, the coefficient retrieving controller 6 are coupled to the 3×3 convolution units of the convolution operation module 3 through the wires of filter coefficients FC and control signals Ctrl. The buffer device 2 can control the convolution units to perform the corresponding convolution operations after retrieving the instructions, convolution information and data.

The interleaving sum unit 4 is coupled to the convolution operation module 3. The convolution operation module 3 can perform operation according to different characteristics of the inputted data and output the characteristics operation results. Regarding to the data writing with multiple characteristics, the convolution operation module 3 can output a plurality of operation results correspondingly. The interleaving sum unit 4 is configured to combine the operation results outputted from the convolution operation module 3 for obtaining an output characteristics result. After obtaining the output characteristics result, the interleaving sum unit 4 transmits the output characteristics result to the sum buffer unit 5 for next process.

For example, the convolutional neural network has a plurality of operation layers, such as the convolutional layer and pooling layer. The convolutional neural network may have a plurality of convolutional layers and pooling layers, and the output of any of the above layers can be the input of another one of the above layers or any consecutive layer. For example, the output of the N convolutional layer is the input of the N pooling layer or any consecutive layer, the output of the N pooling layer is the input of the N+1 convolutional layer or any consecutive layer, and the output of the N operational layer is the input of the N+1 operational layer.

In order to enhance the operation performance, when performing the operation of the Nth layer, a part of the operation of N+i layer will be executed depending on the situation of the operation resource (hardware). Herein, i is greater than 0, and N and i are natural numbers. This configuration can effectively utilize the operation resource and decrease the operation amount in the operation of the N+i layer.

In this embodiment, when executing an operation (e.g. a 3×3 convolution operation), the convolution operation module 3 performs the operation for one convolutional layer of the convolutional neural network. The interleaving sum unit 4 doesn't execute a part of the operation of a consecutive layer in the convolutional neural network, and the sum buffer unit 5 executes an operation for the pooling layer of the same level in the convolutional neural network. When executing another operation (e.g. a 1×1 convolution operation), the convolution operation module 3 performs the operation for one convolutional layer of the convolutional neural network. The interleaving sum unit 4 executes a part of the operation (e.g. a sum operation) of a consecutive layer in the convolutional neural network, and the sum buffer unit 5 executes an operation for the pooling layer of the same level in the convolutional neural network. In other embodiments, the sum buffer unit 5 can execute not only the operation of the pooling layer, but also a part of the operation of a consecutive layer in the convolutional neural network. Herein, a part of the operation can be a sum operation, an average operation, a maximum value operation, or other operations of a consecutive layer, and it can be executed in the current layer of the convolutional neural network.

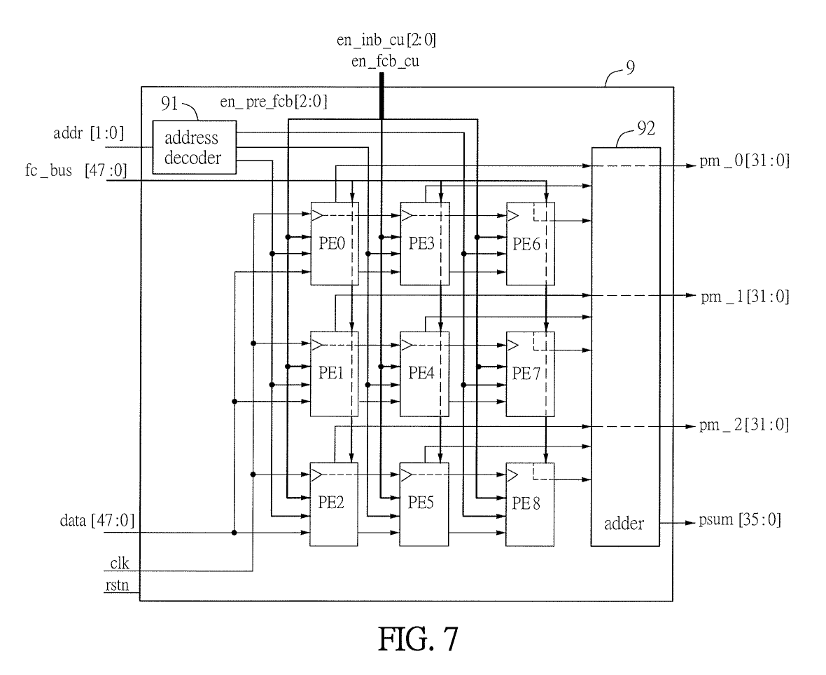

FIG. 7 is a block diagram showing a convolution unit according to an embodiment of the invention. As shown in FIG. 7, the convolution unit 9 includes 9 processing engines PE0˜PE8, an address decoder 91, and an adder 92. The convolution unit 9 can be applied to any of the above-mentioned convolution units.

In a 3×3 convolution operation mode, the inputted data for the convolution operation are inputted to the process engines PE0˜PE2 through the line data[47:0]. The process engines PE0˜PE2 input the inputted data of the current clock to the process engines PE3˜PE5 in the next clock for next convolution operation. The process engines PE3˜PE5 input the inputted data of the current clock to the process engines PE6˜PE8 in the next clock for next convolution operation. The 3×3 filter coefficient can be inputted to the process engines PE0˜PE8 through the line fc_bus[47:0]. If the stride is 1, 3 new data can be inputted to the process engines, and 6 old data are shifted to other process engines. When executing the convolution operation, the process engines PE0˜PE8 execute multiplications of the inputted data, which are inputted to the PE0˜PE8, and the filter coefficients of the addresses selected by the address decoder 91. When the convolution unit 9 executes a 3×3 convolution operation, the adder 92 obtain a sum of the results of multiplications, which is the output psum [35:0].

When the convolution unit 9 performs a 1×1 convolution operation, the inputted data for the convolution operation are inputted to the process engines PE0˜PE2 through the line data[47:0]. Three 1×1 filter coefficients are inputted to the process engines PE0˜PE2 through the line fc_bus[47:0]. If the stride is 1, 3 new data can be inputted to the process engines. When executing the convolution operation, the process engines PE0˜PE2 execute multiplications of the inputted data, which are inputted to the PE0˜PE2, and the filter coefficients of the addresses selected by the address decoder 91. When the convolution unit 9 executes a 1×1 convolution operation, the adder 92 directly uses the results of the convolution operations of the process engines PE0˜PE2 as the outputs pm_0 [31:0], pm_1 [31:0], and pm_2 [31:0]. In addition, since the residual process engines PE3˜PE8 don't perform the convolution operations, they can be temporarily turned off for saving power. Although the outputs of the convolution units 9 include three 1×1 convolution operations, it is possible to select two of the convolution units 9 to couple to the interleaving sum unit 4. Alternatively, three convolution units 9 can be coupled to the interleaving sum unit 4, and the number of the 1×1 convolution operation results to be outputted to the interleaving sum unit 4 can be determined by controlling the ON/OFF of the process engines PE0˜PE2.

After the convolution operation module 3, the interleaving sum unit 4 and the sum buffer unit 5 all process the entire image data, and the final data process results are stored in the memory 1, the buffer device 2 outputs stop signal to the instruction decoder 71 and the control unit 7 for indicating that the current operations have been finished and waiting the next process instruction.

Accordingly, each convolution unit of the convolution operation device can remain a part of the current data after the convolution operation, and the buffer device retrieves a plurality of new data and inputs the new data to the convolution unit. The new data is not duplicated with the current data. Thus, the performance of the convolution operation can be enhanced, so that this invention is suitable for the convolution operation for data stream. When performing data process by convolution operation and continuous parallel operation, the operation performance and low power consumption expressions are excellent, and these operations can be applied to process data stream.

The convolution operation method can be applied to the convolution operation device in the previous embodiment, and the modifications and application details will be omitted here. The convolution operation method can also be applied to other computing devices. For example, the convolution operation method can be performed in a processor that can execute instructions. The instructions for performing the convolution operation method are stored in the memory. The processor is coupled to the memory for executing the instructions so as to performing the convolution operation method. For example, the processor includes a cache memory, a mathematical operation unit, and an internal register. The cache memory is configured for storing the data stream, and the mathematical operation unit is configured for executing the convolution operation. The internal register can remain a part data of the current convolution operation in the convolution operation module, which are provided for the next convolution operation.

In summary, the convolution operation method of the invention includes the following steps of: decomposing a large convolution operation region to multiple small convolution operation regions; performing convolution operations by the small convolution operation regions so as to generate partial results, respectively; and summing the partial results as a convolution operation result of the large convolution operation region. Accordingly, the convolution operation device and method can obtain the convolution operation results of large convolution operation region with reducing the limitation of specific scale of convolution operation region and without the additional hardware resource.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A convolution operation method, comprising following steps of:
decomposing a large convolution operation region to multiple small convolution operation regions;
performing convolution operations by the small convolution operation regions so as to generate partial results, respectively; and
summing the partial results as a convolution operation result of the large convolution operation region.

2. The convolution operation method of claim 1, wherein the small convolution operation regions have the same scale.

3. The convolution operation method of claim 1, further comprising a step of:
assigning 0 to the small convolution operation regions, which are exceeding the large convolution operation region.

4. The convolution operation method of claim 1, wherein, in the step of performing the convolution operations, the small convolution operation regions utilize at least a convolution unit to perform the convolution operations so as to generate the partial results, and a scale of the small convolution operation region is equal to a maximum convolution scale capable of being supported by the convolution unit.

5. The convolution operation method of claim 1, wherein, in the step of performing the convolution operations, the small convolution operation regions utilize convolution units of corresponding numbers to perform the convolution operations in parallel so as to generate the partial results.

6. The convolution operation method of claim 1, wherein the large convolution operation region comprises a plurality of filter coefficients, and the filter coefficients are assigned to the small convolution operation regions according to an order of the filter coefficients and scales of the small convolution operations regions.

7. The convolution operation method of claim 1, wherein the large convolution operation region comprises a plurality of data, and the filter coefficients are assigned to the small convolution operation regions according to an order of the data and scales of the small convolution operations regions.

8. The convolution operation method of claim 1, wherein a scale of the large convolution operation region is 5×5 or 7×7, and a scale of the small convolution operation regions is 3×3.

9. The convolution operation method of claim 1, wherein the step of summing the partial results further comprises:
providing a plurality of moving addresses to the small convolution operation regions, wherein the partial results move in a coordinate according to the moving addresses and added.

10. The convolution operation method of claim 1, further comprising:
determining a convolution operation mode according to a scale of a current convolution operation region;
wherein when the convolution operation mode is a decomposed mode, the current convolution operation region is the large convolution operation region, wherein the large convolution operation region is decomposed to the multiple small convolution operation regions, the small convolution operation regions perform the convolution operations so as to generate the partial results, respectively, and the partial results are summed as the convolution operation result of the large convolution operation region; and
wherein when the convolution operation mode is a non-decomposed mode, the current convolution operation region is not decomposed and directly performs the convolution operation.

11. The convolution operation method of claim 1, further comprising:
performing a partial operation of a consecutive layer of a convolutional neural network.
